(19) United States
(12) Patent Application Publication
(10) Pub. No.: US 2023/0103978 A1
(43) Pub. Date: Apr. 6, 2023

(54) METHOD AND APPARATUS FOR SCHEDULING WORKFLOW ON CLOUD PLATFORMS USING LINUX CRON

(71) Applicant: TENCENT AMERICA LLC, Palo Alto, CA (US)

(72) Inventor: Iraj Sodagar, Los Angeles, CA (US)

(73) Assignee: TENCENT AMERICA LLC, Palo Alto, CA (US)

(21) Appl. No.: 17/704,140

(22) Filed: Mar. 25, 2022

Related U.S. Application Data
(60) Provisional application No. 63/252,328, filed on Oct. 5, 2021.

(51) Int. Cl. G06F 9/52; G06F 9/48

(52) U.S. Cl. CPC G06F 9/52; G06F 9/4881; H04L 67/10

(57) ABSTRACT

Systems and methods for scheduling a workflow are provided. A method may be performed by at least one processor that implements a network-based media processing (NBMP) workflow manager. The method may include obtaining at least one table that indicates at least one from among (i) an execution order of tasks or task groups to be executed in a NBMP workflow and (ii) dependencies among the tasks; and causing the tasks to be executed based on the at least one table. The at least one table may include a schedule table and/or a task execution dependency table.

### CROSS-REFERENCE TO THE RELATED APPLICATION

This application claims priority from U.S. Provisional Application No. 63/252,328, filed on Oct. 5, 2021, the disclosure of which is incorporated herein by reference in its entirety.

### FIELD

Embodiments of the present disclosure are directed to a set of various schemes for scheduling a workflow or parts of the workflow on cloud platforms using, for example, Linux Cron utility.

### BACKGROUND

Network and cloud platforms are used to run various applications. The network-based media processing (NBMP) standard defines a specification for defining, instantiating, and running workflows on cloud platforms. However, the existing standard does not define methods for scheduling a workflow, or parts of it.

### SUMMARY

In some use cases, a workflow can be run in parts, task by task, or a group of tasks at each time. In such an application, real-time processing may not be a requirement and for reasons such as limited computational resources allocated for the workflow or to avoid peak traffic time on the cloud, a workflow may be needed to be scheduled.

Embodiments of the present disclosure solve the above problems and/or other problems.

According to embodiments, a method performed by at least one processor that implements a NBMP workflow manager is provided. The method includes: obtaining at least one table that indicates at least one from among (i) an execution order of tasks or task groups to be executed in a NBMP workflow and (ii) dependencies among the tasks, wherein the at least one table uses Unix or Linux cron string format; and causing the tasks to be executed based on the at least one table.

According to one or more embodiment, the at least one table includes a schedule table that indicates identifiers of the tasks or the task groups in the execution order of the tasks or the task groups.

According to one or more embodiment, the schedule table further indicates a starting time of the tasks or the task groups.

According to one or more embodiment, the schedule table further indicates a duration of the tasks or the task groups.

According to one or more embodiment, the at least one table further includes a table that indicates the dependencies among the tasks.

According to one or more embodiment, the method further includes receiving information that indicates that the execution order of the schedule table is to be looped, wherein the causing the tasks to be executed comprises looping, based on receiving the information, the tasks in the execution order based on the schedule table.

According to one or more embodiment, the obtaining the at least one table comprises receiving the schedule table.

According to one or more embodiment, the at least one table includes a table that indicates the dependencies among the tasks.

According to one or more embodiment, the causing the tasks to be executed comprises deriving the execution order of the tasks based on the at least one table that indicates the dependencies among the tasks, and causing the tasks to be executed in the execution order that is derived.

According to one or more embodiment, the cron string format supports at least one from among: indicating a list of allowed values by the allowed values being separated with a comma; indicating an unrestricted range by using “*”; indicating a range by using “-”; indicating that a value may be one or another by using “?”; indicating a last day of a week or month by using “L”; indicating a specific week day by using “W”; indicating a specific day of a month by using “#”; and indicating step values.

According to embodiments, a system is provided. The system includes: at least one memory configured to store computer program code; and at least one processor configured to access the computer program code and operate as instructed by the computer program code, the computer program code comprising: obtaining code configured to cause a NBMP workflow manager, implemented by the at least one processor, to obtain at least one table that indicates at least one from among (i) an execution order of tasks or task groups to be executed in a NBMP workflow and (ii) dependencies among the tasks, wherein the at least one table uses Unix or Linux cron string format; and executing code configured to cause the NBMP workflow manager to cause the tasks to be executed based on the at least one table.

According to one or more embodiment, the at least one table includes a schedule table that indicates identifiers of the tasks or the task groups in the execution order of the tasks or the task groups.

According to one or more embodiment, the schedule table further indicates a starting time of the tasks or the task groups.

According to one or more embodiment, the schedule table further indicates a duration of the tasks or the task groups.

According to one or more embodiment, the at least one table further includes a table that indicates the dependencies among the tasks.

According to one or more embodiment, the executing code is further configured to cause the NBMP workflow manager to loop, based on receiving information that indicates that the execution order of the schedule table is to be looped, the tasks in the execution order based on the schedule table.

According to one or more embodiment, the at least one table includes a table that indicates the dependencies among the tasks.

According to one or more embodiment, the executing code is further configured to cause the NBMP workflow manager to derive the execution order of the tasks based on the table that indicates the dependencies among the tasks, and cause the tasks to be executed in the execution order that is derived.

According to one or more embodiment, the cron string format supports at least one from among: indicating a list of allowed values by the allowed values being separated with a comma; indicating an unrestricted range by using “*”; indicating a range by using “-”; indicating that a value may be one or another by using “?”; indicating a last day of a week or month by using “L”; indicating a specific week day by using “W”; indicating a specific day of a month by using “#”; and indicating step values.

According to embodiments, a non-transitory computer-readable medium storing computer code is provided. The computer code is configured to, when executed by at least one processor, cause the at least one processor to implement a NBMP workflow manager that: obtains at least one table that indicates at least one from among (i) an execution order of tasks or task groups to be executed in a NBMP workflow and (ii) dependencies among the tasks, wherein the at least one table uses Unix or Linux cron string format; and causes the tasks to be executed based on the at least one table.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a block diagram of an NBMP system, according to embodiments.

FIG. 4 is a diagram showing an example of schedule fields in Unix/Linux cron string format, according to embodiments.

FIG. 5 is a diagram of an example NBMP workflow according to embodiments.

FIG. 6 is a block diagram of computer code according to embodiments.

### DETAILED DESCRIPTION

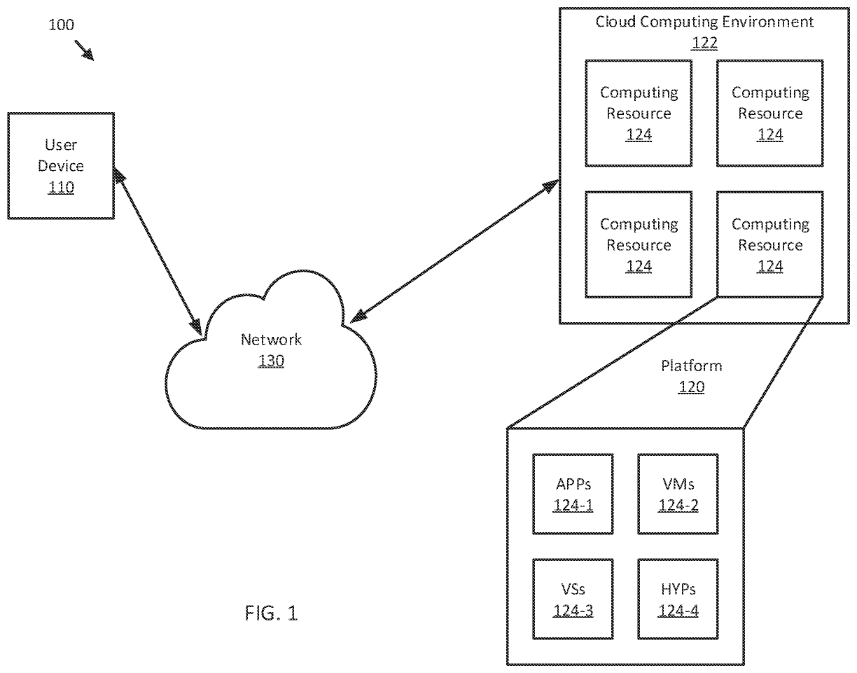

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

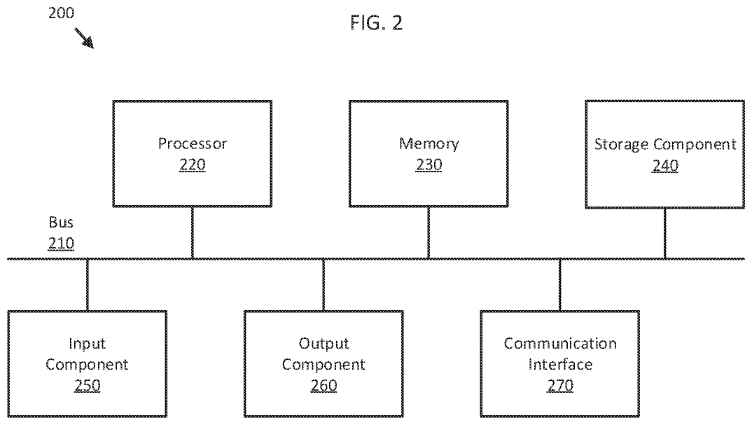

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

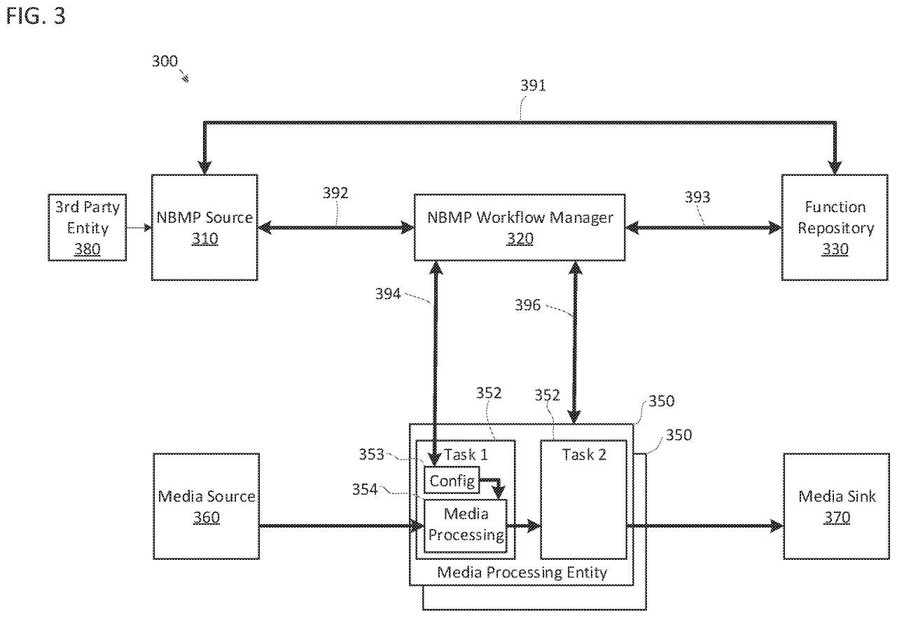

In an embodiment of the present disclosure, an NBMP system 300 is provided. With reference to FIG. 3, the NBMP system 300 comprises an NBMP source 310, an NBMP workflow manager 320, a function repository 330, one or more media processing entities 350, a media source 360, and a media sink 370.

The NBMP source 310 may receive instructions from a third party entity 380, may communicate with the NBMP workflow manager 320 via an NBMP workflow API 392, and may communicate with the function repository 330 via a function discovery API 391. For example, the NBMP source 310 may send a workflow description document(s) (WDD) to the NBMP workflow manager 320, and may read the function description of functions stored in the function repository 330, the functions being media processing functions stored in memory of the function repository 330 such as, for example, functions of media decoding, feature point extraction, camera parameter extraction, projection method, seam information extraction, blending, post-processing, and encoding. The NBMP source 310 may comprise or be implemented by at least one processor and memory that stores code configured to cause the at least processor to perform the functions of the NBMP source 310.

The NBMP source 310 may request the NBMP workflow manager 320 to create workflow including tasks 352 to be performed by the one or more media processing entities 350 by sending the workflow description document, which may include several descriptors, each of which may have several parameters.

For example, the NBMP source 310 may select functions stored in the function repository 330 and send the workflow description document to the NBMP workflow manager 320 that includes a variety of descriptors for description details such as input and output data, required functions, and requirements for the workflow. The workflow description document may include a set of task descriptions and a connection map of inputs and outputs of tasks 352 to be performed by one or more of the media processing entities 350. When the NBMP workflow manager 320 receives such information from the NBMP source 310, the NBMP workflow manager 320 may create the workflow by instantiating the tasks based on function names and connecting the tasks in accordance with the connection map.

Alternatively or additionally, the NBMP source 310 may request the NBMP workflow manager 320 to create workflow by using a set of keywords. For example, NBMP source 310 may send the NBMP workflow manager 320 the workflow description document that may include a set of keywords that the NBMP workflow manager 320 may use to find appropriate functions stored in the function repository 330. When the NBMP workflow manager 320 receives such information from the NBMP source 310, the NBMP workflow manager 320 may create the workflow by searching for appropriate functions using the keywords that may be specified in a Processing Descriptor of the workflow description document, and use the other descriptors in the workflow description document to provision tasks and connect them to create the workflow.

The NBMP workflow manager 320 may communicate with the function repository 330 via a function discovery API 393, which may be a same or different API from the function discovery API 391, and may communicate with one or more of the media processing entities 350 via an NBMP task API 394. The NBMP workflow manager 320 may also communicate with one or more of the media processing entities 350 via a media processing entity (MPE) API 396. The NBMP workflow manager 320 may comprise or be implemented by at least one processor and memory that stores code configured to cause the at least processor to perform the functions of the NBMP workflow manager 320.

The NBMP workflow manager 320 may use the NBMP task API 394 to setup, configure, manage, and monitor one or more tasks 352 of a workflow that is performable by the one or more media processing entities 350. In an embodiment, the NBMP workflow manager 320 may use the NBMP task API 394 to update and destroy the tasks 352. In order to configure, manage, and monitor tasks 352 of the workflow, the NBMP workflow manager 320 may send messages, such as requests, to one or more of the media processing entities 350, wherein each message may have several descriptors, each of which have several parameters. The tasks 352 may each include media processing functions 354 and configurations 353 for the media processing functions 354.

In an embodiment, after receiving a workflow description document from the NBMP source 310 that does not include a list of the tasks (e.g., includes a list of keywords instead of a list of tasks), the NBMP workflow manager 320 may select the tasks based on the descriptions of the tasks in the workflow description document to search the function repository 330, via the function discovery API 393, to find the appropriate functions to run as tasks 352 for a current workflow. For example, the NBMP workflow manager 320 may select the tasks based on keywords provided in the workflow description document. After the appropriate functions are identified by using the keywords or the set of task descriptions that is provided by the NBMP source 310, the NBMP workflow manager 320 may configure the selected tasks in the workflow by using the NBMP task API 394. For example, the NBMP workflow manager 320 may extract configuration data from information received from the NBMP source, and configure the tasks 352 based on the configuration data.

The one or more media processing entities 350 may be configured to receive media content from the media source 360, process the media content in accordance with the workflow, that includes tasks 352, created by the NBMP workflow manager 320, and output the processed media content to the media sink 370. The one or more media processing entities 350 may each comprise or be implemented by at least one processor and memory that stores code configured to cause the at least processor to perform the functions of the media processing entities 350.

The media source 360 may include memory that stores media and may be integrated with or separate from the NBMP source 310. In an embodiment, the NBMP workflow manager 320 may notify the NBMP source 310 when a workflow is prepared and the media source 360 may transmit media content to the one or more of the media processing entities 350 based on the notification that the workflow is prepared.

The media sink 370 may comprise or be implemented by at least one processor and at least one display that is configured to display the media that is processed by the one or more media processing entities 350.

The third party entity 380 may comprise or be implemented by at least one processor and memory that stores code configured to cause the at least processor to perform the functions of the third party entity 380.

As discussed above, messages from the NBMP Source 310 (e.g., a workflow description document for requesting creation of a workflow) to the NBMP workflow manager 320, and messages (e.g., for causing the workflow to be performed) from the NBMP workflow manager 320 to the one or more media processing entities 350 may include several descriptors, each of which may have several parameters. In cases, communication between any of the components of the NBMP system 300 using an API may include several descriptors, each of which may have several parameters.

[Unix/Linux Cron Format]

The Unix/Linux cron format is a simple scheduler table with one or more of the following line:
“run this command at this time on this date”

Each line has five time-and-date fields followed by a command. Commands are executed by cron when the “minute”, “hour”, and “month of the year” fields match the current time, and at least one of the two “day” fields (“day of month”, or “day of week”) match the current time.

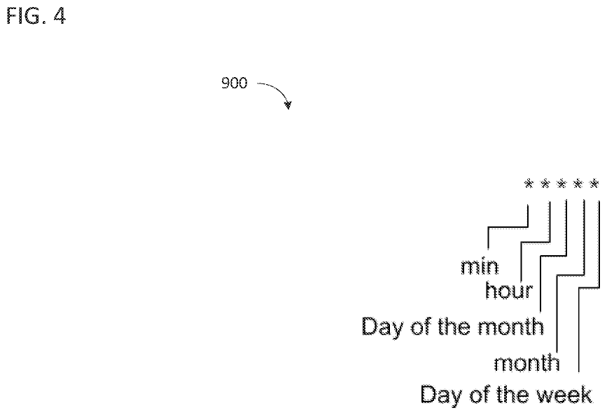

A schedule may be described using the Unix/Linux cron string format (* * * * *), which is a set of five values in a line, indicating when a job should be executed. An example of schedule fields 900 in Unix/Linux cron string format are shown in FIG. 4. For example, the schedule fields 900 may include “min,” “hour,” “day of the month,” “month,” and “day of the week.”

Time-zone can be set in cron. The default time zone may be Coordinated Universal Time (UTC).

According to embodiments, the following features are supported:

1. List of allowed values, comma separated.

2. Unrestricted range using “*”

3. Range using “-”

4. One or another using “?”

5. Last day of week/month using “L”

6. Day of a month that is a specific week day using “W”

7. The specific occurrence of day of the month using “#”

8. Step values using first-last/step

[Scheduling and Task Dependency]

The below TABLE 1 shows an example schedule according to embodiments.

TABLE 1
Example Schedule

| | Cloud |
|---|---|
| | Scheduler |
| Example Schedule | Format |
| Every min | * * * * * |
| Every Saturday at 23:45 (11:45 PM) | 45 23 * * 6 |
| Every Monday at 09:00 | 0 9 * * 1 |

An aspect of cron is that cron is a scheduler for firing a process. Cron does not have the concept of duration (i.e., how long a process should be run). Cron also does not have the concepts of events or order (i.e., sequencing the processes).

For the above reasons, there is another tool, rate expression, which defines to run a process at certain rate (e.g., every 5 minute, every 2 days, etc.). The syntax for the rate expression is the following: rate(value unit), where valid values are minute minutes hour hours day days.

In summary, cron is a time-based scheduler that lacks duration.

Embodiments of the present disclosure may solve problems described above, and other problems.

According to embodiments of the present disclosure, a task execution dependency table is provided. The task execution dependency table maintains the execution dependencies of various tasks in a workflow. To describe various scheduling schemes, a workflow example is described below.

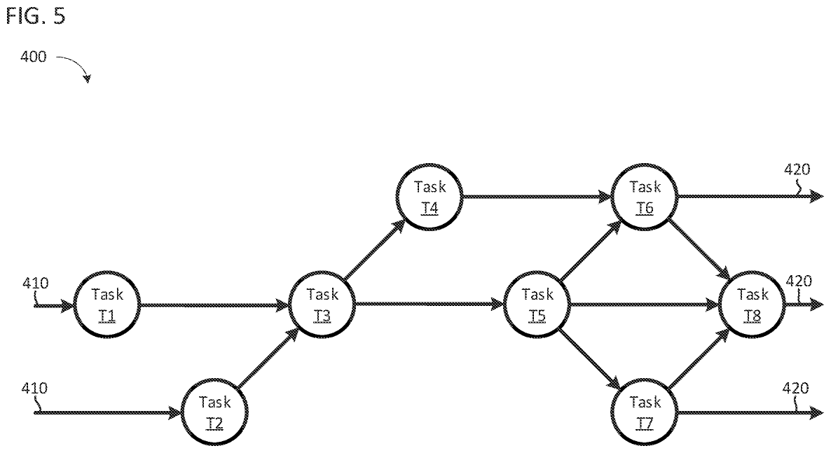

With reference to FIG. 5, a non-limiting example of an NBMP workflow is described. FIG. 5 represents the NBMP workflow as a directed acyclic graph (DAG). According to embodiments, the NBMP workflow manager 320 may create and manage an NBMP workflow 400 that includes one or more tasks (e.g., tasks T1-T8). For example, as shown in FIG. 5, the tasks T1-T8 may be associated with various inputs 410 and may be configured to provide various outputs 420. The inputs 410 on the left edge of FIG. 5 (e.g., inputs of tasks T1-T2) are inputs of the NBMP workflow 400. The outputs 420 on the right edge of FIG. 5 (e.g., outputs of tasks T6-T8) are outputs of the NBMP workflow 400.

According to embodiments, the tasks of a workflow may be implemented in one or more media processing entities 350, the media source 360 and/or the media sink 370. In embodiments, the media source 360 may be a source device/platform, the one or more media processing entities 350 may be a cloud node/edge network, and the media sink 370 may be a sink device/platform.

The workflow DAG of FIG. 5 defines the characteristics shown below in TABLE 2.

TABLE 2
Task Execution Dependency Table

| Dependencies | Order |
|---|---|
| T3 after T1 and T2 | T1 and T2 |
| T4 after T3 | T4 and T5 |
| T5 after T3 | T6 and T7 |
| T6 after T4 and T5 | |
| T7 after T5 | |
| T8 after T6 and T7 | |

In summary, any task in the workflow may be required to be run after running the task(s) that it is dependent on (i.e., a task's inputs may require another task's outputs).

According to embodiments, as examples, the tasks of the workflow 400 of FIG. 5 may executed in one of the orders shown in TABLE 3 below.

TABLE 3
Execution Order Examples

| Order 1 | Order 2 | Order 3 |
|---|---|---|
| 1. T1 | 1. T2 | 1. T1 and T2 |
| 2. T2 | 2. T1 | 2. T3 |
| 3. T3 | 3. T3 | 3. T4 and T5 |
| 4. T4 | 4. T5 | 4. T6 and T7 |
| 5. T5 | 5. T4 | 5. T8 |
| 6. T6 | 6. T7 | |
| 7. T7 | 7. T6 | |
| 8. T8 | 8. T8 | |

[Scheduling Schemes]

Embodiments of the present disclosure may implement the following schemes for each task:
1. By order: each task of the workflow is run once for its entire inputs in an order, wherein a task in the workflow is run after running the task(s) in the workflow that it is dependent on.
2. By order with a limited duration (by duration): each task in the workflow is run such that one duration of input/output is consumed/produced (e.g., 1 minute of inputs, or 5 minutes of output(s)), wherein the order is dictated by a DAG observed.
3. By timeslot: each task starts according to a specific schedule and runs for a specific duration.

According to embodiments, the above schemes can be run for a group of tasks (or a task group). The schemes are described in more detail below.

A. By Order

In the by order scheme mode, the NBMP workflow manager 320 may be required to run each task at a time. Therefore, the NBMP workflow manager 320 may start from tasks that have the input(s) of the workflow, generate the outputs of such tasks, buffer them, and then start the next tasks in a moving wave fashion toward the outputs of the workflow. The DAG may define the order of tasks.

For example, referring to the workflow 400 shown in FIG. 5, an example order of execution of tasks may be as follows:
1. T1 (or T2) for the entire input
2. T2 (or T1) for the entire input
3. T3
4. T4 (or T5)
5. T5 (or T4)
6. T6 (or T7)
7. T7 (or T6)
8. T8

B. By Duration

In the by duration scheme mode, the NBMP workflow manager 320 may be required to run each task for a specific duration of input or output. Therefore, the NBMP workflow manager 320 may be required to start from tasks that have the input(s) of the workflow, generate the outputs of such tasks for that duration, buffer them, and then start the next tasks in a moving wave fashion toward the output(s) of the workflow. The DAG may define the order of tasks.

For example, referring to the workflow 400 shown in FIG. 5, an example order of execution of tasks may be as follows:
1. T1 (or T2) for 5 minutes
2. T2 (or T1) for 5 minutes
3. T3 for 5 minutes
4. T4 (or T5) for 5 minutes
5. T5 (or T4) for 5 minutes
6. T6 (or T7) for 5 minutes
7. T7 (or T6) for 5 minutes
8. T8 for 5 minutes
9. Go back to step (1)

C. By Timeslot

In the by timeslot scheme mode, an NBMP client may provide a schedule for each task to the NBMP workflow manager 320 and the NBMP workflow manager 320 may run each task according to the schedule (e.g., according to a given timeslot in the schedule).

According to embodiments, the NBMP client may be an NBMP source 310.

For example, referring to the workflow 400 shown in FIG. 5, an example order of execution of tasks may be as follows:
1. T1 (or T2) starts at time t0 and stops at time t1
2. T2 (or T1) starts at time t0 and stops at time t1
3. T3 start at time t1 and stop at time t2
4. T4 (or T5) start at time t2 and stop at time t3
5. T5 (or T4) start at time t2 and stop at time t3
6. T6 (or T7) start at time t3 and stop at time t4
7. T7 (or T6) start at time t4 and stop at time t5
8. T8 start at time t5 and stop at time t6
9. Go back to step (1)

[Schedule Table]

According to embodiments, a schedule table may accommodate the schemes described in the present disclosure. TABLE 4 below shows an example schedule table that accommodates the schemes. The example schedule table may be similar to a cron table but is extended with durations/number of segments.

TABLE 4
Schedule Table

| | | Duration/ |
|---|---|---|
| Task/Task | Starting | Number of |
| Group ID | Time | Segments |
| id1 | S1 | D1 |
| id2 | S2 | D2 |
| ... | ... | ... |
| idn | Sn | Dn |

According to embodiments, the order of IDs in the first column may be required to be consistent with the workflow DAG.

According to embodiments, for the by order scheme, only the first column may be used.

According to embodiments, for the by duration scheme, the first column, the first value in the second column (starting time), and the third column may be used.

According to embodiments, for the scheduling by timeslot scheme, all columns may be used.

According to embodiments, the table may be looped. That is, after completing the last row, the schedule may be required to go back to the first row. For example, according to embodiments, the NBMP workflow manager 320 may cause the tasks to be executed in order based on the schedule table, and may loop execution of the tasks based on the schedule table (e.g., after task idn is executed, task id1 then task id2, etc., is executed again).

According to embodiments, the NBMP client may create the schedule table and/or the task execution dependency table, and send the table(s) to the NBMP workflow manager 320. According to embodiments, the NBMP workflow manager 320 may schedule and execute a workflow based on the schedule table and/or the task execution dependency table received. According to embodiments, the NBMP workflow manager 320 may derive the schedule table and/or the task execution dependency table and may execute workflow based on the schedule table and/or the task execution dependency table that is derived.

[Implementation in NBMP]

According to embodiments, a scale descriptor may be implemented in NBMP to address the scheduling of a workflow.

The scale descriptor may include the parameters shown below in TABLE 5.

TABLE 5
Scale Descriptor

| Parameter | | |
|---|---|---|
| Name | Type | Cardinality |
| id | P | 1 |
| description | P | 0-1 |
| schedule- | P | 0-1 |
| type | | |
| schedule- | Array | 0-1 |
| table | of objects | |
| loop | P | 0-1 |
| status | P | 1 |

The “schedule-table” object may include the parameters shown below in TABLE 6.

TABLE 6
Schedule-Table Object

| Parameter | | |
|---|---|---|
| Name | Type | Cardinality |
| task-id | P | 1 |
| start-time | string | 0-1 |
| number-of- | P | 0-1 |
| segments | | |
| duration | P | 0-1 |
| timescale | P | 0-1 |

According to embodiments, if a task/task group execution runs out of input data, the task may be controlled (e.g., by the NBMP workflow manager 320) to go to “idle” and the NBMP workflow manager 320 may start executing the next task/task group in the schedule table.

According to embodiments, the scale descriptor may include the scale parameters shown below in TABLE 7.

TABLE 7
Scale Parameters

| | | | | Valid |
|---|---|---|---|---|
| Name | Definition | Unit | Type | range |
| id | unique string indicating the schedule | N/A | string | N/A |
| | request in the scope of Workflow | | | |
| description | a human-readable description | N/A | string | N/A |
| | for the schedule request | | | |
| schedule- | type of schedule request, which may | N/A | string | N/A |
| type | have one of the following values: | | | |
| | (a) “duration”: with a specific order | | | |
| | and for a specific duration | | | |
| | (b) “segment”: for a specific | | | |
| | number of segments | | | |
| | The default value may be “duration”. | | | |
| start-time | Start-time in cron time format (five time | N/A | string | N/A |
| | parameters) as defined by [Cron]. | | | |
| | If a task/task group’s start-time is “/null”, | | | |
| | then that task/task group is started right | | | |
| | after completion of the previous task in the | | | |
| | schedule table. | | | |
| | If the first task/task group’s start time is | | | |
| | “/null”, then the first task/task group starts | | | |
| | immediately after receiving | | | |
| | the schedule descriptor. | | | |
| number-of- | The number of inputs/outputs segments to | N/A | unsigned | nonzero |
| segments | be processed for “schedule-type” = “segment” | | integer | |
| | This value id may be ignored when | | | |
| | “schedule-type” = “duration”. | | | |
| duration | The duration of inputs/outputs in the unit of | ticks | unsigned | N/A |
| | the timescale for “schedule-type” = “duration”. | | integer | |
| | If duration is “0”, the task/task group is run | | | |
| | for its entire input(s). | | | |
| | This value may be ignored when “schedule- | | | |
| | type” = “segment”. | | | |
| timescale | The number of ticks per second used for the | N/A | unsigned | N/A |
| | duration unit for “schedule-type” = “duration” | | integer | |
| | This value may be ignored when “schedule- | | | |
| | type” = “segment”. | | | |
| loop | If “TRUE”, then the schedule table is looped. | N/A | boolean | N/A |
| | At each loop, the start times are offset by | | | |
| | the entire duration of the previous loop | | | |
| | when “schedule-type” = “duration”. | | | |
| | At each loop but the first one, the start times | | | |
| | may be ignored when “schedule-type” = “segments”. | | | |
| | The default value may be “FALSE”. | | | |
| status | Status of the schedule request, which may | N/A | string | N/A |
| | have one of the following values: | | | |
| | (a) “capabilities”: request the capabilities | | | |
| | (b) “consider”: investigate whether such | | | |
| | schedule is possible to accommodate | | | |
| | (c) “request”: request scheduling | | | |
| | (d) “passed”: accommodated/possible to | | | |
| | accommodate | | | |
| | (e) “failed”: failed/not possible | | | |
| | The default value may be “failed”. | | | |

According to embodiments, the NBMP client can include the scale descriptor in a workflow description document (WDD) update call for the following functions: (a) get capabilities of the NBMP workflow manager 320 by including the scale descriptor in WDD, wherein the “status” parameter has a value equal to “capabilities”; (b) schedule the workflow by including the scale descriptor in WDD; (c) consider scheduling any of the above by sending a request (e.g., to the NBMP workflow manager 320) that the includes the scale descriptor, wherein the “status” parameter” has a value equal to “consider” to see if the workflow can manage the schedule if the NBMP workflow manager 320 is requested to do so.

According to embodiments, to perform the above functions (and/or other functions), the NBMP client can obtain (e.g., create or update) the WDD, to include the scale descriptor, and then send the WDD to the NBMP workflow manager 320. According to embodiments, in response, the NBMP workflow manager 320 may, for example, perform functions such as sending its capabilities to the NBMP client, scheduling a workflow, and/or indicating to the NBMP client whether the NBMP workflow manager 320 can manage a schedule, based on values of parameters included in the scale descriptor of the WDD that is received. For example, the NBMP workflow manager 320 may obtain the ID of a schedule request in the scope of a workflow, a description of the schedule request, a type of the schedule request, a schedule table object, task or task group start times, a number of inputs/outputs segments to be processed, a duration of inputs and/or outputs of tasks, a time scale, whether a schedule table is to be looped, and/or a status of the schedule request, and the NBMP workflow manager 320 may perform its functions (e.g., scheduling/managing a workflow) based thereon.

According to embodiments, a method may be provided that includes describing various scheduling schemes for executing parts of an entire workflow on a cloud platform. The scheduling schemes may include modes of scheduling by a specific order of tasks, or by duration limited order of tasks, or by explicit scheduling of each task. The various scheduling schemes may be described in a descriptor that describes the schedule type, the information regarding the specific type of schedule, and one or more command. The execution order of tasks may be derived (e.g., by an NBMP workflow manager) from an execution dependency table that is derived from the workflow, wherein a data object array defines a table of start time and the duration or number of segments for each task or task groups, wherein the cron time format is used for defining the start time, wherein if looping is desired, it is signaled (e.g., to the NBMP workflow manager), wherein the various commands can be requests including getting the capabilities of the cloud platform, checking if scheduling can be implemented, or requesting scheduling to be implemented. The descriptor may also be updated (e.g., by the NBMP workflow manager) to include a response(s) to the request(s).

[Example Computer Code]

According to embodiments of the present disclosure, at least one processor with memory storing computer code may be provided. The computer code may be configured to, when executed by the at least one processor, perform any number of aspects of the present disclosure.

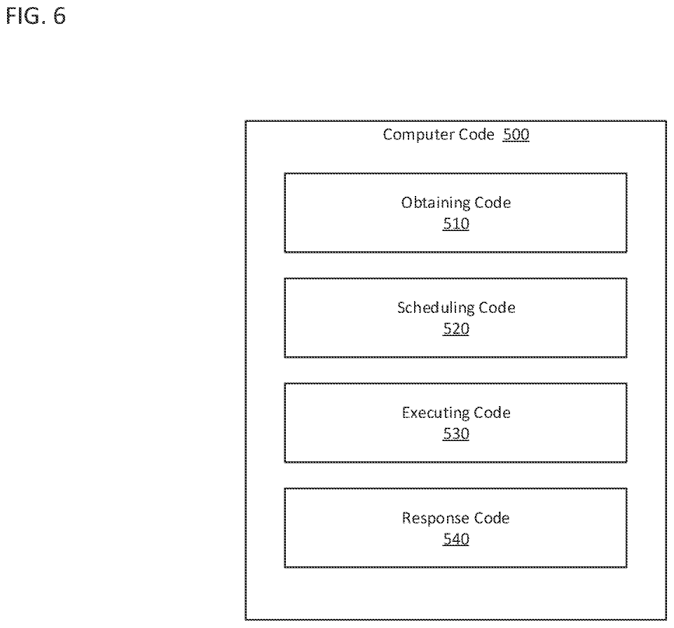

For example, with reference to FIG. 6, computer code 500 may be implemented in the NBMP system 300. For example, the computer code may be stored in memory of the NBMP workflow manager 320 and may be executed by at least one processor of the NBMP workflow manager 320. The compute code may comprise, for example, obtaining code 510, scheduling code 520, executing code 530, and response code 540.

The obtaining code 510 may be configured to cause the NBMP workflow manager 320 to obtain information from a WDD that is sent by, for example, an NBMP client. For example, the NBMP workflow manager 320 may receive the WDD, and any number of the scale parameters (e.g., refer to TABLE 7) and/or tables (e.g., a schedule table and/or a task execution dependency table) therein may be signaled to the NBMP workflow manager 320 such that the NBMP workflow manager 320 obtains corresponding information. For example, the NBMP workflow manager 320 may obtain the ID of a schedule request in the scope of a workflow, a description of the schedule request, a type of the schedule request, a list of task IDs in an order of execution, a duration of inputs/outputs, a time scale, a number of inputs/outputs segments to be processed, an io-flag, a run mode of a task(s), a status of the schedule request, a timeslot mode, a state time of the timeslot for a task(s), an end time for the timeslot for the task(s), a time increment to the next start time, and/or a duration of time for the time increment, and performs its functions (e.g., scheduling/executing/managing a workflow) based thereon. According to embodiments, the NBMP workflow manager 320 may obtain a scheme mode for scheduling a media processing workflow. According to embodiments, the NBMP workflow manager 320 may derive a schedule table and/or a task execution dependency table.

The scheduling code 520 may be configured to cause the NBMP workflow manager 320 to schedule the workflow (including tasks therein) for execution based on the information obtained by the NBMP workflow manager 320. For example, the NBMP workflow manager 320 may schedule the workflow in accordance with the obtained scheme mode and based on any other information described in the present disclosure that is received by the NBMP workflow manager 320 from the NBMP client, including the other parameters of the scale descriptor and/or table objects. According to embodiments, the NBMP workflow manager 320 may derive aspects of the workflow, and its tasks, based on the information received by the NBMP workflow manager 320, and schedule the workflow based on the derived aspects. For example, an execution order of tasks may be derived by the NBMP workflow manager 320 from the task execution dependency table, that may also be derived.

The executing code 530 may be configured to cause the NBMP workflow manager 320 to cause the tasks of the workflow, as scheduled, to be implemented in one or more media processing entities 350, the media source 360 and/or the media sink 370. According to embodiments, the NBMP workflow manager 320 may execute workflow based on the schedule table and/or the task execution dependency table that is obtained from the NBMP client or derived by the NBMP workflow manager 320.

The response code 540 may be configured to cause the NBMP workflow manager 320 to send, to the NBMP client, a response to a request received from the NBMP client. According to embodiments, the request may be included in the scale descriptor of the WDD. According to embodiments, the request may be to: (a) get capabilities of workflow manager 320 by including the scale descriptor in the WDD, wherein “status” parameter has a value equal to “capabilities”; (b) schedule the workflow by including the scale descriptor in the WDD; (c) schedule a task by including the scale descriptor in a task description document (TDD); (d) schedule a group of tasks by including the scale descriptor in a Task group object; and (e) consider scheduling any of the above by sending a request that includes the scale description, wherein the “status” parameter has a value equal to “consider” to see if the NBMP workflow manager 320 can manage the schedule if the NBMP workflow manager 320 is requested to do so. In addition to performing the request, the NBMP workflow manager 320 may provide a corresponding response to the NBMP client. For example, the response may indicate its capabilities to the NBMP client, indicate to the NBMP client whether the NBMP workflow manager 320 can manage a schedule, and/or whether the NBMP workflow manager 320 can or did perform a particular request.

According to one or more embodiments, embodiments of the present disclosure may be implemented in environments different from NBMP.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or described in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor that implements a network-based media processing (NBMP) workflow manager, the method comprising:
obtaining, by the NBMP workflow manager, at least one table that indicates at least one from among (i) an execution order of tasks or task groups to be executed in a NBMP workflow and (ii) dependencies among the tasks, wherein the at least one table uses Unix or Linux cron string format; and
causing the tasks to be executed based on the at least one table.

2. The method of claim 1, wherein the at least one table includes a schedule table that indicates identifiers of the tasks or the task groups in the execution order of the tasks or the task groups.

3. The method of claim 2, wherein the schedule table further indicates a starting time of the tasks or the task groups.

4. The method of claim 2, wherein the schedule table further indicates a duration of the tasks or the task groups.

5. The method of claim 2, wherein the at least one table further includes a table that indicates the dependencies among the tasks.

6. The method of claim 2, further comprising receiving information that indicates that the execution order of the schedule table is to be looped,
wherein the causing the tasks to be executed comprises looping, based on receiving the information, the tasks in the execution order based on the schedule table.

7. The method of claim 2, wherein the obtaining the at least one table comprises receiving the schedule table.

8. The method of claim 1, wherein the cron string format supports at least one from among:
indicating a list of allowed values by the allowed values being separated with a comma;
indicating an unrestricted range by using “*”;
indicating a range by using “-”;
indicating that a value may be one or another by using “?”
indicating a last day of a week or month by using “L”;
indicating a specific week day by using “W”;
indicating a specific day of a month by using “#”; and
indicating step values.

9. The method of claim 1, wherein the causing the tasks to be executed comprises deriving the execution order of the tasks based on the at least one table that indicates the dependencies among the tasks, and causing the tasks to be executed in the execution order that is derived.

10. The method of claim 1, wherein the at least one table includes a schedule table that indicates identifiers of the tasks or the task groups in the execution order of the tasks or the task groups.

11. A system comprising:
at least one memory configured to store computer program code; and
at least one processor configured to access the computer program code and operate as instructed by the computer program code, the computer program code comprising:
obtaining code configured to cause a network-based media processing (NBMP) workflow manager, implemented by the at least one processor, to obtain at least one table that indicates at least one from among (i) an execution order of tasks or task groups to be executed in a NBMP workflow and (ii) dependencies among the tasks, wherein the at least one table uses Unix or Linux cron string format; and
executing code configured to cause the NBMP workflow manager to cause the tasks to be executed based on the at least one table.

12. The system of claim 11, wherein the at least one table includes a schedule table that indicates identifiers of the tasks or the task groups in the execution order of the tasks or the task groups.

13. The system of claim 12, wherein the schedule table further indicates a starting time of the tasks or the task groups.

14. The system of claim 12, wherein the schedule table further indicates a duration of the tasks or the task groups.

15. The system of claim 12, wherein the at least one table further includes a table that indicates the dependencies among the tasks.

16. The system of claim 12, wherein the executing code is further configured to cause the NBMP workflow manager to loop, based on receiving information that indicates that the execution order of the schedule table is to be looped, the tasks in the execution order based on the schedule table.

17. The system of claim 11, wherein the at least one table includes a table that indicates the dependencies among the tasks.

18. The system of claim 17, wherein the executing code is further configured to cause the NBMP workflow manager to derive the execution order of the tasks based on the table that indicates the dependencies among the tasks, and cause the tasks to be executed in the execution order that is derived.

19. The system of claim 11, wherein the cron string format supports at least one from among:
indicating a list of allowed values by the allowed values being separated with a comma;
indicating an unrestricted range by using “*”;
indicating a range by using “-”;
indicating that a value may be one or another by using “?”;
indicating a last day of a week or month by using “L”;
indicating a specific week day by using “W”;
indicating a specific day of a month by using “#”; and
indicating step values.

20. A non-transitory computer-readable medium storing computer code that is configured to, when executed by at least one processor, cause the at least one processor to implement a network-based media processing (NBMP) workflow manager that:
obtains at least one table that indicates at least one from among (i) an execution order of tasks or task groups to be executed in a NBMP workflow and (ii) dependencies among the tasks, wherein the at least one table uses Unix or Linux cron string format; and
causes the tasks to be executed based on the at least one table.
